(19) United States
(12) Patent Application Publication
(10) Pub. No.: US 2004/0068756 A1
(43) Pub. Date: Apr. 8, 2004

(54) Virtual link between CE devices

(75) Inventor: Tom Chiu, Sunnyvale, CA (US)

Correspondence Address: PHILIPS ELECTRONICS NORTH AMERICA CORPORATION, INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V.

(21) Appl. No.: 10/263,586

(22) Filed: Oct. 2, 2002

(51) Int. Cl. H04N 5/44; H04N 11/00; H04N 7/00; H04N 7/16; H04N 7/173

(52) U.S. Cl. 725/135; 725/136; 348/460; 348/461; 348/734

(57) ABSTRACT

In a home network environment, a control device is provided for controlling the communication flow between devices over the network. The control device generates and transmits a first control command in response to a first user input. The first control command is received by a first device on the network and upon reception of the first control command, the first device broadcasts, to a plurality of devices over a network comprising at least the first device and a second device, information data representative of a pending content transfer over the network from the first device. Thereafter, the control device generates and transmits a second control command in response to a subsequent second user input. The second control command is received by the second device and in response to the second control command contacts the first device and enables the initiation of the content transfer from the first device to the second device. The transfer may be automatically activates or it is ultimately activated by the user.

### FIELD OF THE INVENTION

The invention relates to networks of consumer electronics (CE) devices and the invention provides a way to configure devices on a network to transfer content data from one to another. The invention is particularly relevant to home environments. The invention further pertains to an apparatus for enabling controlling the flow of communications over such CE networks.

### BACKGROUND ART

The home environment is gradually migrating from a collection of stand-alone devices to one or more networks of interconnected consumer electronics devices. Home networks are no longer limited to personal computers that often only expert users can install and easily manipulate. Several standards, e.g. HAVI, UPnP, RendezVous, Zigbee, IEEE 802.11, have been developed by the CE industry along with the PC industry to enable easy and reliable interoperation and communication among these consumer electronics devices that are not traditionally connected in a network configuration. These standards are gaining acceptance throughout the CE market and as a consequence new applications have been developed for the user to interact with these devices and the content they provide.

A major advance is that devices communicate and co-operate with each other to perform applications whereas the same devices, when taken alone, are conventionally dedicated to the performance of a set of predefined applications. Stand-alone CE devices all together offer a tremendous number of available functionalities although some devices are more appropriately designed than others to perform a given task. Once these devices are interconnected, advantage is taken of this great variety of available resources, e.g. communication capabilities, processing, playing, rendering, audio and display resources, and new combinations and sharing of these resources provide new experience and new ways of enjoying content and interacting with it. For example, users may now decide where content should be stored, on which device to process the content, and ultimately on which device the final result should be played-out or displayed to him.

The inventor has realized that one of the user's expectations with respect to home networks is freedom and flexibility on how to render or transfer content. Flexibility includes being able to define at any time the configuration of the network and which task each device will perform for a given application. For example, a user may want to be able choose where to watch a TV program: a TV show stored in a set-top box in the living room can be streamed to a TV screen in the bedroom or, alternately, to another TV screen in the living room. However, although the user does not want to limit his ability to freely reconfigure a home network, he also does not want to be burdened with heavy and complicated set-up and manipulations each time he desires to change the way in which devices communicate with each other.

### SUMMARY OF THE INVENTION

An object of the invention is to provide the user with a simple method for controlling the flow of communications over a network.

It is another object of the invention to provide the user with a flexible network.

Another object of the invention is to take advantage of control devices with which the user is familiar to control content transfers over a network.

To this end, an apparatus of the invention comprises a user input device for receiving a first user input and a subsequent second user input. The apparatus further comprises a selection module for, in response to the first user input, transmitting a first control command to a first device. In response to the first control command the first device transmits, over a network comprising at least the first device and a second device, information data respecting a future content transfer from the first device over the network. The selection module further transmits a second control command to the second device in response to the second user input. In response to the second control command the second device notifies the first device to enable conditionally initiating the content transfer from the first device to the second device.

The invention also relates to a system comprising such apparatus, first device and second device.

In the context of the invention, the first and the second devices both belong to the same network and as a consequence both devices can readily communicate over a wired or wireless communication link. The invention provides an apparatus with which the user can easily select this communication link to transfer content from the first device to the second device or, alternately, with which the user can select another communication link between the first device and another device on the network if the user does not want to transfer content from the first device to the second device. An advantage of the invention is the flexibility that such a network offers, which ultimately permits the user to have some control over the way communications flow over the network.

Thus, for a particular content transfer to take place according to the invention, the transmitting device from which content originates, e.g. content source or content processing unit, waits for the user to indicate which device on the network will act as the receiving party for this particular content transfer. To this end, the user first indicates to the first device that it will act as the transmitting party and requests the first device to indicate so to other devices on the network by transmitting, e.g. broadcasting, a message respecting the content transfer. To this end, the user provides a first user input to a control apparatus of the invention, which in turn sends a first control command to the transmitting device itself. Such apparatus of the invention is possibly a remote controller that is conventionally used to control the first and the second devices. The remote controller may be a well-known in the art bi-directional remote controller. When in a learning mode, the remote controller may be loaded with new commands codes for controlling new devices or new functionalities of known devices. The user transmits the first control command by placing it in the vicinity of the first device and by subsequently depressing one of its keys to trigger the first control command.

In an embodiment of the invention, interested devices on the network that received the broadcast message may store it for further use as is explained hereinafter. A device will further need and process the stored message if the user selects that device later on to be the receiving party for the particular content transfer associated with the stored message. Indeed, in a second step, the user enters a second user-input into the apparatus and in response to the second user-input, the apparatus issues a second control command. The second control command is received by a second device, which in response to the second control command contacts the first device to enable conditionally initiating the content transfer from the first device to the second device. The second device communicates with the first device over the network. The content transfer may be actually initiated upon command by the user. Alternately, the content transfer may be a pre-scheduled content transfer that will take place in the future. In the example described above, the user may place the remote controller in front of the second device and the remote controller transmits the second control command upon the user depressing a key, the second user input. The user thereby indicates to the second device that it will be the receiving device for the content transfer. In the invention, the user pulls a “virtual link” between the first and the second devices by indicating to the first device that it is the transmitting party and that it needs to wait for further information to actually transfer content, and by subsequently indicating to the second device that it will be the receiving party and that it needs to contact the first device to initiate the content transfer.

An advantage of the invention is to provide an apparatus with which the user can control the communications flow over a network. Thus, when a source device could transfer its content to more than one potential candidate over the network, the invention provides an easy way to select one or more these candidates to actually receive content.

### BRIEF DESCRIPTION OF THE DRAWING

The invention is explained in further details, by way of examples, and with reference to the accompanying drawing wherein:

FIG. 1 is a block diagram of a system of the invention;

FIG. 2 is a flow chart of an embodiment of the invention;

FIG. 3 is a block diagram of a device of the invention; and

FIG. 4 is a flow-chart of another embodiment of the invention.

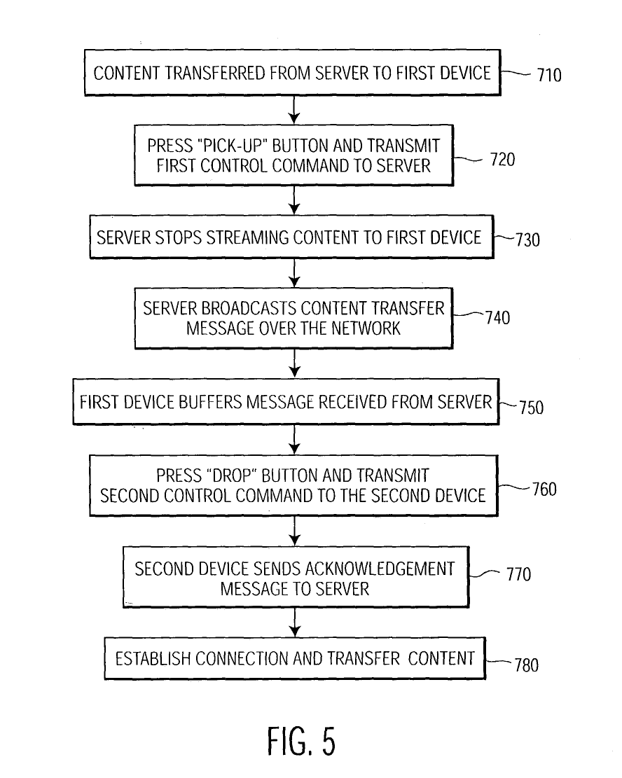

Elements within the drawing having similar or corresponding features are identified by like reference numerals.

### DETAILED DESCRIPTION

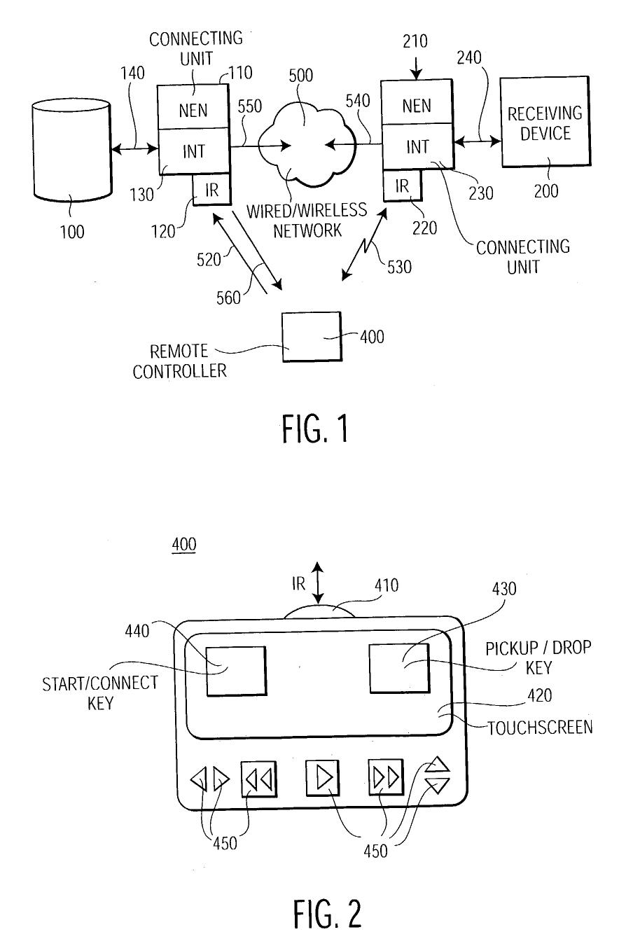

In the following, the invention is described in the context of home networks consisting primarily of interconnected CE devices however the invention may be applied to other types of networks such as personal and private networks, corporate networks or public networks comprising either CE devices only, professional electronic devices, other interconnected electronic apparatus or a combination of the like. In the present context, several devices share resources and permit a user to interact with content that is either stored locally on the network or accessed from remote repository outside the home network. The invention provides an easy way to the user to manage content transfers over the network. A system of the invention is depicted in FIG. 1 where devices 100 and 200 can communicate over a home network 500. Network 500 may be a wired or a wireless network or a combination of the like, e.g. network 500 is compliant with IEEE 802.11, Zigbee, RendezVous protocol, UpnP (Universal Plug and Play), HAVI or any other wireless or wired network standard or protocol. In the embodiment of FIG. 1, network 500 is a UPnP network.

FIG. 1 illustrates a content transfer scenario where the user desires to transfer content from device 100 to device 200 over network 500. The invention pertains to a way to set up both devices 100 and 200 to transfer content as the user desires. Device 100 is possibly a content source where textual, audio or video content is generated, a repository or database where content is stored with a multitude of other audio/video content pieces, a gateway where content originating from a repository outside the network is temporarily stored or simply going through or a processing device processing content stored on another device on the network 500. Device 100 is, for example, a home gateway, a home server, a personal video recorder, a VCR, an optical storage medium (e.g. CD, DVD, minidisk, SACD) player, a personal computer, a digital camera, a set top box or the like. Device 200 is possibly a repository or database where received content is stored with a multitude of other A/V content pieces, a gateway or a processing device which processes received content for rendering it or before further passing it to another apparatus. Device 200 is, for example, a television set or any other type of display apparatus, a personal digital assistant, a sound system, a set top box or a personal computer.

Devices 100 and 200 may communicate over network 500 via respective network interfaces 130 and 230 shown as network dongles connected to devices 100 and 200. Dongles 130, 230 are further associated with respective memories 110 and 210 where data associated with network 500 and devices on network 500 is stored. Such data may include among others: security data, encryption key, MAC or IP addresses, supported bit rates, list, profiles and abstract representation of other devices on network 500. It must also be noted that although network interfaces 130 and 230 are shown as being external to devices 100 and 200, devices 100 and 200 may be built in with network capabilities, e.g. devices 100 and 200 are UPnP devices, in which case, interfaces 130, 230 are embedded in devices 100, 200. In this embodiment where interfaces 130, 230 are built separately from devices 100, 200, interfaces 130, 230 may communicate with respective devices 100, 200 over respective analog A/V 1394 links 140, 240. In this embodiment, device 100 is a server.

Interfaces 130, 230 have IR capability and thus comprise respective IR sensors 120, 220. The user may control interfaces 130, 230 and also devices 100, 200 with an IR remote controller 400. In another embodiment, devices 100 and 200 are equipped with internal IR sensors 120, 220 and can be thus controlled through IR directly without passing through interfaces 130, 230. As will be shown hereinafter, the user may control the transfer of content from server 100 to device 200 with remote controller 400 that has been preprogrammed with a content transfer application of the invention.

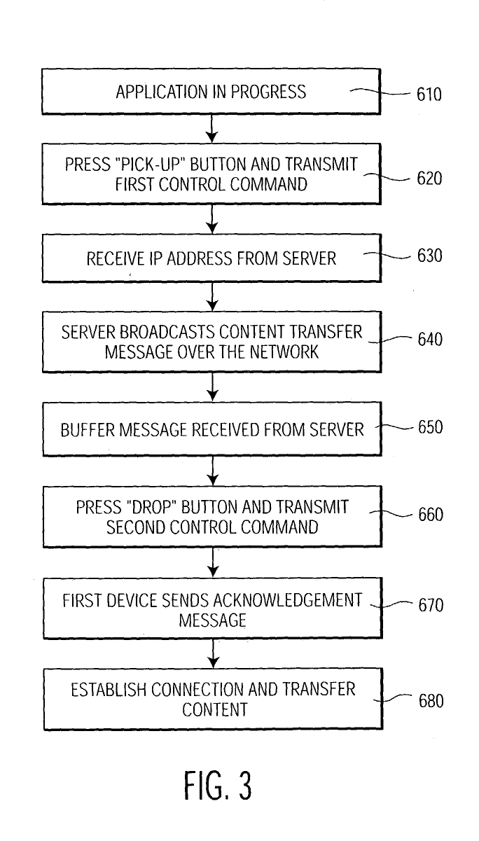

FIG. 2 is a detailed embodiment of controller 400. Controller 400 comprises a series of buttons 450 used to control CE devices in the network 500. The buttons 450 offer basic functionality control such as adjustment of the volume, fast-forwarding or back-playing a scene, channel switching, jumping tracks on an optical recording medium and/or operating and control of the play-back of content. Controller 400 also has a display 420 such as an LCD display for providing feedback to the user on the control and operating of controlled devices. In this embodiment, the display 420 is a touch-screen display and further enables the display of control icons, which upon depression or touch cause the transmission of control commands to a controlled device. Controller 400 is further equipped with a bi-directional IR sensor 410 for transmitting and receiving IR modulated signals representative of codes for generating control commands or representative of the commands themselves.

Controller 400 is user re-configurable and when set in a learning mode, controller 400 may be loaded with new software applications or software updates, and/or commands codes for controlling new devices, new features of devices already known to controller 400 or new applications performed by controlled devices. In this embodiment, controller 400 is configured to control devices 100 and 200, directly or via interfaces 130, 230 and codes for commands to control these two devices 100, 200 are stored in a memory arrangement of controller 400. As mentioned above, controller 400 has been loaded with a content transfer application of the invention. FIG. 2 shows two icons associated with this content transfer application: “start/connect” soft button 440 and “pickup/drop” soft button 430. The user uses buttons 430 and 440 to configure both devices 100, 200 to transfer a piece of content from server 100 to device 200.

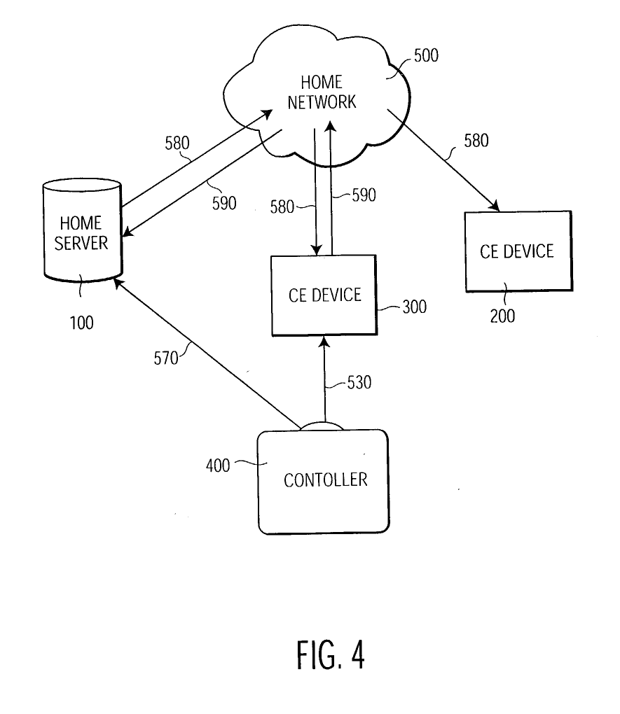

FIG. 3 gives some steps on how the user can set up server 100 and device 200 to transfer content from one to another according to the invention. In a first step 610, the content transfer application of remote controller 400 is activated and display 420 of controller 400 shows soft buttons 430 and 440. In a step 620, the user holds controller 400 so that IR sensor 120 of server 100 is in the receiving range of IR sensor 410 of controller 400. Then the user may depress soft button 440 and causes controller 400 to transmit a first control command 520 to the interface unit 130 of server 100. In response to the first control command 520, interface 130 retrieves an IP address of server 100 on UPNP network 500. UPnP uses Web protocols to enable devices such as PCs, peripherals, intelligent appliances, and wireless devices to be plugged into a network and automatically know about each other. With UPnP, each UPnP device that the user plugs onto the network 500 configures itself, acquires a TCP/IP address and uses a discovery protocol based on the Internet hypertext transfer protocol (HTTP) to announce and advertise its presence on to other devices onto the network. A UPnP enabled device carries out such discovery procedure automatically without the user having to do complicated set up manipulation. Thus, each device onto network 500 is assigned an IP address once installed onto network 500. Devices onto network 500 may be assigned respective IP addresses via DHCP (Dynamic Configuration Host Protocol). Memory 110 stores the IP address of server 100 and interface 130 further conveys this IP address to controller 400 in step 630. To this end, IR sensor 120 transmits to controller 400 an IR encoded signal 560. The IR encoded signal 560 may be modulated with at least the IP address of server 100. However in another embodiment, controller 400 does not receive any response signal 560 from server 100 in response to the transmitted control command 520.

In step 640, interface 130 further transmits, in response to the first control command 520 received from controller 400, a message 550 respecting a pending transfer of content from server 100 to another device onto network 500. Data relating to the content transfer may have been previously transmitted by the user via controller 400 or may have been transmitted as part of the first control command 520. For example, the user may have selected prior to performing the steps disclosed in FIG. 3, a list of MP3 songs stored at server 100 to be transferred. In another example, the content transfer may correspond to a scheduled broadcast of a TV program or Web conference to device 100 that the user wants to render or store onto device 200 when the TV program or the Web conference is actually broadcast in the future. It is to be noted that content to be transferred may be stored at server 100 or alternately at any other device connected to server 100. In this embodiment, server 100 has the possibility of transferring content to more than one potential candidates on network 500, among which is device 200 and as a result, server 100 may not start transmitting content until it knows which of the candidates will be the actual receiving device. For example, server 100 may be a personal video recorder where episodes of the user's favorite show are currently stored. The user has two TVs, one on his living room and a second one in his bedroom. The user's personal video recorder and the TVs are connected over a network and as a consequence, the episodes may be played out on either TV. The invention permits the user to choose on which TV to play each episode and to configure the three devices to do so. The user may watch each episode on a different TV set and reconfigures the personal video recorder and the two TV sets for each episode. As will be shown hereinafter, the user may also interrupt the transfer of one episode on one of the TV set and view the end of it on the other TV set. In such case, the transfer of the episode from the personal video recorder to the first TV set is interrupted and redirected to the second TV set.

Server 100 may transmit message 550 to selected devices of network 500 or server 100 may broadcast message 550 to all devices onto network 500. Memory 110 may store a list of all UPnP devices present on network 500 and memory 110 may also comprise respective abstract representations of these devices giving each device's functionalities, its capabilities, its control modalities and the required control parameters to control that device. Server 100 may transmit message 550 to devices of network 550 that are likely to be interest in receiving content based on their technical capabilities. For example, server 100 may determine that a stereo system that does not have any display or storage capability will not be interested in message 550 respecting the transfer of video content only.

In a step 650, one or more of the devices on network 500 buffers the received message 550. Device 200 stores the received messages descriptive of the pending content transfer along with other previously received messages respecting other content transfers over network 500 or other networks. The received message 550 may comprise IP address of server 100. In another embodiment, device 200 stores message 550 at the top of a message queue consisting in all messages received in an elapsed period of time.

In a step 660, the user holds controller 400 in the vicinity of device 200 and enters a second user input into controller 400, i.e. the user depresses the “pickup/drop” soft button 430, which causes controller 400 to transmit a second control command 530. Second control command 530 may comprise at least the IP address of server 100 if controller 400 previously received from server 100 as shown in step 630 in response to the first control command 520. In response to the second control command 530, device 200 compares the received IP address with IP addresses comprised in stored messages respecting content transfers and retrieves message 550 previously stored. In a step 670, device 200 sends acknowledgment message 530 to server 100 indicating to server 100 that it will be the receiving party. Device 200 may erase other buffered messages respecting other content transfers over network 500. Device 200 or server 100 may also thereafter broadcast a command to other devices to erase message 550 stored in their message queue. Alternately message 550 may comprise a time-stamp, which upon expiration causes the message to be ignored or deleted by the device storing it.

In another embodiment, the control command 530 does not include the IP address of server 100 and may also not enable to identify server 100. In this other embodiment, once the user has pressed the “pickup/drop” key 430 in step 620, controller 400 sends the first control command 520 indicating to the device receiving it, i.e. server 100, that it is the transmitting device, and the content transfer application further causes controller 400 to be ready to issue a second control command 530 which indicates to the receiving device, device 200, that it is the receiving device with respect to the content transfer. Controller 400 issues the second control command 530 upon the user depressing again the key 430. When the user presses the “pickup/drop” button 430 in step 630, the control command 530 indicates to the device 200 that it will act as the receiving device for the content transfer associated with the message received last. In this other embodiment, command 530 does not enable to identify the transmitting device, server 100. Device 200 therefore checks its queue of messages and retrieves the last message received, i.e. message 550. Message 550 comprises the IP address of server 100 and device 200 can therefore identify the transmitting party. Device 200 thereafter contacts server 100 as explained in step 670.

Upon device 200 contacting server 100 in step 680, a connection may be established between server 100 and device 200 onto network 500. The transfer of content may be automatically initiated from server 100 to device 200 or the transfer may be activated upon the user depressing the “start” button 440 of controller 400.

FIG. 5 shows another system of the invention illustrating another content transfer scenario of the invention. FIG. 5 proposes a method for redirecting a content transfer. Network 500 comprises server 100 and devices 200 and 300. Device 300 is possibly a repository or database where received content is stored with a multitude of other A/V content pieces, a gateway or a processing device which processes received content for rendering it or before further passing it to another apparatus. Device 300 can be similar to device 200. In this embodiment, the user has set up devices 200, 300 and server 100 following the steps of configuration process of FIG. 3 to transfer content from server 100 to device 200. This embodiment illustrates a scenario where the user wishes to have content transferred to device 300 instead of device 200. For example, the user was watching a collection of digital pictures stored on a home server on his PC screen and now desires to view them on a TV screen in the kitchen.

Thus, in a first step 710 of such a transfer switching process the content is originally being transferred from server 100 to first device 200. In a second step 720, the user presses the “pickup/drop” button 330 of controller 400, which causes a control command 570 to be transmitted to server 100. In response to received control command 570, server 100 interrupts, in a step 730, the transfer of content to device 200 and pauses the transfer. In step 740, server 100 also broadcasts a content transfer message 580 to devices on network 500. Message 580 comprises data respecting the content transfer and both devices 200 and 300 may receive it. In a next step 750, the second device 300 and other devices on network 500 store the received message 580 for later use. The received message 580 may comprise the IP address of server 100. The user thereafter approaches second device 300 and transmits the second control command 530 to the second device 300 in a similar manner described in step 660. Final steps 770 and 780 of a redirecting process of the invention comprise second device 300 sending an acknowledgment message 590 to server 100 informing server 100 that server 100 will stream content to second device 300. Steps 770 and 780 enable establishing a communication link between server 100 and device 300. Ultimately, either server 100 or device 300 may re-activate the content transfer from server 100 to device 300 upon reception of a further command from the user transmitted via controller 400. Alternately, server 100 may automatically initiate the content transfer upon reception of the acknowledgment message 590. Steps 740-780 may be similar to steps 640-680 previously described.

It is to be noted that other modulation formats may be used for the transfer of control commands may be used such as RF modulated signals instead of IR modulated signals.

It is further to be understood that the embodiment of control 400 such as depicted in FIG. 2 is by no way a limitation of the invention and other types of apparatus such as a PDA are also encompassed. In addition the embodiment disclosed the user enters inputs into controller 400 using the “Start/connect” and “pickup/drop” soft keys however any other user interface elements, e.g. more than two soft keys, speech inputs, hard keys, scroll wheel, etc. . . . , are also within the scope of the invention.

What is claimed is:

1. An apparatus comprising:
a user input device for receiving a first user input and a subsequent second user input;
a selection module for, in response to the first user input, transmitting a first control command to a first device causing the first device to transmit, over a network comprising at least the first device and a second device, information data respecting a future content transfer from the first device over the network, and for in response to the second user input, transmitting to the second device a second control command causing the second device to communicate with the first device to enable conditionally activating the content transfer from the first device to the second device.

2. The apparatus of claim 1, wherein the first device broadcasts the information data over the network.

3. The apparatus of claim 1, further comprising:
an acquisition module for acquiring identification data from the first device.

4. The apparatus of claim 3, wherein the selection module further transmits the identification data to the second device in response to the second user input from the user.

5. The apparatus of claim 1, wherein the first and second control commands comprise IR modulated signals.

6. The apparatus of claim 1, wherein the first control command is associated with the first device and the second control command is associated with the second device.

7. The apparatus of claim 1, wherein the selection module is user-configurable to control the first and the second devices.

8. The apparatus of claim 1, wherein the first and the second user inputs comprise depressing a key of the apparatus.

9. A system comprising:
a control device for transmitting a first control command in response to a first user input and for subsequently transmitting a second control command in response to a subsequent second user input;
a first device configured to, upon reception of the first control command, broadcast, to a plurality of devices over a network comprising at least the first device and a second device, information data representative of a pending content transfer over the network from the first device;
the second device configured to inform the first device to conditionally initiate the content transfer from the first device to the second device upon reception of the second control command.

10. The system of claim 9, wherein the first device initiates the content transfer to the second device upon reception of a start command from the user.

11. The system of claim 9, wherein the control device is further configured to acquire identification data respecting the first device.

12. The system of claim 11, wherein the control device further transmits the identification data to the second device in response to the second user input.

13. The system of claim 9, wherein the control device is user configurable to control the first and the second devices.

14. The system of claim 9, wherein the network comprising the first and the second devices is a wireless local area network or a UPnP network.

15. The system of claim 9, wherein the second device stores the information data and is configured to identify the first device from the stored information data.

16. The system of claim 9, wherein the second device further comprises:
a memory arrangement for storing the information data comprising identification data respecting the first device and for storing a second information data respecting another pending content transfer from a third device on the network, the second information data comprising second identification data respecting the third device; and, a comparator for comparing a portion of the second control command with the first and the second identification data.

17. A software application comprising computer-executable instructions for performing the following steps:
enabling receiving a first user input and a subsequent second user input;
causing to transmit, in response to the first user input, a first control command causing a first device, receiving the first control command, to transmit, over a network comprising at least the first device and a second device, information data respecting a future content transfer from the first device over the network; and, causing to transmit, in response to the second user input, a second control command causing the second device, receiving the second control command, to communicate with the first device to activate the content transfer from the first device to the second device.
